(19) United States
(12) Patent Application Publication
(10) Pub. No.: US 2006/0198075 A1
(43) Pub. Date: Sep. 7, 2006

(54) Lightning surge protection circuit and radio-frequency signal processing device having the same

(75) Inventor: Masahiro Kato, Nagaokakyo-shi (JP)

Correspondence Address: BIRCH STEWART KOLASCH & BIRCH, PO BOX 747, FALLS CHURCH, VA, 22040-0747, US

(73) Assignee: Sharp Kabushiki Kaisha

(21) Appl. No.: 11/357,992

(22) Filed: Feb. 22, 2006

(30) Foreign Application Priority Data
Mar. 2, 2005 (JP) 2005-057872

(51) Int. Cl. H02H 3/22

(52) U.S. Cl. 361/118

(57) ABSTRACT

A lightning surge protection circuit according to the present invention is a serial circuit of a surge absorber (1) and a diode (2), and a terminal of the surge absorber (1) corresponding to the cathode of a diode is connected to the cathode of the diode (2). The lightning surge protection circuit according to the present invention is used in such a way that a terminal of the surge absorber (1) corresponding to the anode of a diode is grounded, and the anode of the diode (2) is connected to a power supply line of a product such as an LNB or a SW-BOX. A varistor (6) may be used instead of the surge absorber (1), and a capacitor (4, 7) may be used instead of the diode (2).

This nonprovisional application claims priority under 35 U.S.C. § 119(a) on Patent Application No. 2005-057872 filed in Japan on Mar. 2, 2005, the entire contents of which are hereby incorporated by reference.

### BACKGROUND OF THE INVENTION

1. Field of the Invention

The present invention relates to a lightning surge protection circuit that prevents damage by lightning strikes, and a radio-frequency signal processing device having the same.

2. Description of Related Art

Since LNBs (low noise down-converters), SW-BOXes (IF signal switching SW units), and the like are designed for outdoor use, they need to be provided with a lightning surge protection circuit for preventing damage by lightning strikes (for example, see JP-A-H11-155232). Conventionally, although the lighting surge test conditions vary depending on the place of destination of products or the specification requested by the user, they conform to IEC standards. IEC standards prescribe that a voltage surge test should be performed for products such as LNBs (low noise down converters) or SW-BOXes that input and output at high impedance, and a current surge test should be performed for products that input and output at low impedance.

In the voltage surge test, a waveform that would result from lightning strikes is simulated with the product that inputs and outputs at high impedance, and therefore it is possible to make the waveform at the rising and falling edges of a voltage when the surge output terminals of a testing machine are in an open state substantially equal to the waveform at the rising and falling edges of a voltage to be applied to the product by the testing machine in the voltage surge test. A level indicating the severity of the test can be determined by a voltage to be applied to the product.

Conventionally, a surge test voltage of at least ±3 kV having the waveform with a rise time of 10 μs and a fall time of 700 μs shown in FIG. 8 is applied to the products such as LNBs or SW-BOXes to be exported to the United States where particularly strict specifications are required. As a precaution to make them survive such a surge test voltage, a 1500 W surface mounting surge absorber is inserted in a power supply line of the products such as LNBs or SW-BOXes to be exported to the United States, thereby protecting the circuit thereof. Like a Zener diode, the surge absorber instantaneously absorbs a current surge when a voltage becomes equal to or higher than a breakdown voltage, protecting the circuit by grounding a terminal thereof corresponding to the anode of a diode.

In recent years, however, the specifications of the products such as LNBs or SW-BOXes to be exported to the United States require that such products should survive a surge test voltage of ±4 kV or higher. As a result, mere insertion of the currently-used 1500 W surge absorber no longer gives the product sufficiently high surge withstand voltage.

The reason for such strict requirement specifications is that some regions in the United States, such as California, experience lightning strikes 90 or more days per year, and are frequently damaged by lightning strikes. Damage resulting from lightning strikes is caused not only when the product is directly hit by a lightning strike but also when lightning strikes occur in the areas surrounding a point where the product is installed. In a case where lightning strikes occur in the area surrounding a point where the product is installed, damage is caused, for example, by a so-called indirect lightning strike by which a breakdown occurs due to a surge in applied voltage when a voltage of the earth's surface in the surrounding areas rises for even a moment.

Moreover, many of the reports on malfunctions of the products on the market relate to damage resulting from lightning strikes. This proves that voltage surge test simulation has difficulty in duplicating actual lightning strikes. However, since rejection rates on the market can be actually reduced by raising the level of surge withstand voltage obtained by such test simulation, improvement in surge withstand voltage, which eventually leads to improvement in quality, will be increasingly sought after.

Since withstand voltage of the surge absorber is fixed, surge withstand voltage of the product may be improved by connecting a resistance in series to the surge absorber, thereby reducing a voltage to be applied to the surge absorber when lightning strikes occur by a voltage dropped by the resistance. However, connecting a resistance in series to the surge absorber would affect the original function of the surge absorber that protects the circuit by instantaneously dropping a voltage when lightning strikes occur.

### SUMMARY OF THE INVENTION

It is an object of the present invention to provide a lightning surge protection circuit that can achieve higher surge withstand voltage without impairing a protective function thereof, and a radio-frequency signal processing device having the same.

To achieve the above object, a lightning surge protection circuit of the present invention includes a serial circuit of a surge absorber and a diode. With this configuration, it is possible to reduce a voltage to be applied to the surge absorber when lightning strikes occur by a voltage dropped by the diode. Since withstand voltage of the surge absorber is fixed, the lightning surge protection circuit configured as described above can achieve higher surge withstand voltage than a conventional lightning surge protection circuit composed only of a surge absorber. Moreover, since the lightning surge protection circuit configured as described above has the surge absorber connected in series not to a resistance but to the diode, the original function thereof that protects the circuit by instantaneously dropping a voltage when lightning strikes occur is not impaired.

Moreover, it is possible to achieve the same effect by using a varistor instead of the surge absorber in the lightning surge protection circuit configured as described above.

Moreover, it is possible to achieve the same effect by using a capacitor instead of the diode in the lightning surge protection circuit configured as described above.

Moreover, the lightning surge protection circuit configured as described above may be provided with a trap portion that traps a radio-frequency signal in a predetermined frequency band. With this configuration, when the lightning surge protection circuit is provided on a DC line of a radio-frequency signal processing device in which an RF line and the DC line are connected to each other, it is possible to reduce transmission loss of an RF signal by trapping an RF signal entering the DC line.

To achieve the above object, a radio-frequency signal processing device (e.g., an LNB or a SW-BOX) according to the present invention is so configured as to include the lightning surge protection circuit having any of the configurations described above. With this configuration, it is possible to achieve higher surge withstand voltage without impairing a protective function. This makes it possible to reliably prevent the devices constituting the internal circuit of the radio-frequency signal processing device from being deteriorated or damaged.

### BRIEF DESCRIPTION OF THE DRAWINGS

FIG. 1 is a diagram showing one example of the configuration of the lightning surge protection circuit according to the present invention.

FIG. 2 is a diagram showing a modified example of the lightning surge protection circuit according to the present invention.

FIG. 3 is a diagram showing a modified example of the lightning surge protection circuit according to the present invention.

FIG. 4 is a diagram showing a modified example of the lightning surge protection circuit according to the present invention.

FIG. 5 is a diagram showing a modified example of the lightning surge protection circuit according to the present invention.

FIG. 6 is a diagram showing another example of the configuration of the lightning surge protection circuit according to the present invention.

FIG. 7 is a diagram showing still another example of the configuration of the lightning surge protection circuit according to the present invention.

FIG. 8 is a diagram showing a waveform of surge test voltage.

FIG. 9 is a diagram showing an example of connection between the SW-BOX, the receivers, and the LNBs.

FIG. 10 is a diagram showing the circuit configuration in the vicinity of the receiver connection terminal of the SW-BOX according to the present invention.

### DETAILED DESCRIPTION OF PREFERRED EMBODIMENTS

One example of the configuration of the lightning surge protection circuit according to the present invention is shown in FIG. 1. The lightning surge protection circuit shown in FIG. 1 is a serial circuit of a surge absorber 1 and a diode 2, and a terminal of the surge absorber 1 corresponding to the cathode of a diode is connected to the cathode of the diode 2. The lightning surge protection circuit shown in FIG. 1 is used in such a way that a terminal of the surge absorber 1 corresponding to the anode of a diode is grounded, and the anode of the diode 2 is connected to a power supply line of a product such as an LNB or a SW-BOX.

The lightning surge protection circuit shown in FIG. 1 reduces a voltage to be applied to the surge absorber 1 when lightning strikes occur by a voltage dropped by the diode 2 by connecting the diode 2 in series to the surge absorber 1. Since withstand voltage of the surge absorber 1 is fixed, the lightning surge protection circuit shown in FIG. 1 can achieve higher surge withstand voltage than a conventional lightning surge protection circuit composed only of a surge absorber. Moreover, since the lightning surge protection circuit shown in FIG. 1 has the surge absorber 1 connected in series not to a resistance but to the diode 2, the original function thereof that protects the circuit by instantaneously dropping a voltage when lightning strikes occur is not impaired.

Moreover, the lightning surge protection circuit shown in FIG. 1 may be configured as shown in FIG. 2 by adding a microstrip line 3 and a capacitor 4 thereto. One end of the microstrip line 3 serves as one end of the lightning surge protection circuit shown in FIG. 2, and the node at which the other end of the microstrip line 3, the anode of the diode 2, and one end of the capacitor 4 are connected together serves as the other end of the lightning surge protection circuit shown in FIG. 2. The lightning surge protection circuit shown in FIG. 2 is used in such a way that a terminal of the surge absorber 1 corresponding to the anode of a diode and the other end of the capacitor 4 are grounded, and it is inserted in a DC line of a product such as an LNB or a SW-BOX. The microstrip line 3 is a trap device that traps an RF signal, and a line length thereof is set at ¼ wavelength of an RF signal to be trapped. The capacitor 4 serves to ground a capacitor 4 side end portion of the microstrip line 3 with respect to a wavelength of λ, preventing leakage of an RF signal by raising an impedance corresponding to a wavelength of λ.

Moreover, it is possible to achieve the same effect as the lightning surge protection circuit shown in FIG. 2 by adopting the configuration shown in FIG. 3 where the microstrip line 3 of the lightning surge protection circuit shown in FIG. 2 is replaced with a coil 5. The coil 5 is a trap device that traps an RF signal, and corresponds to ¼ wavelength of an RF signal to be trapped.

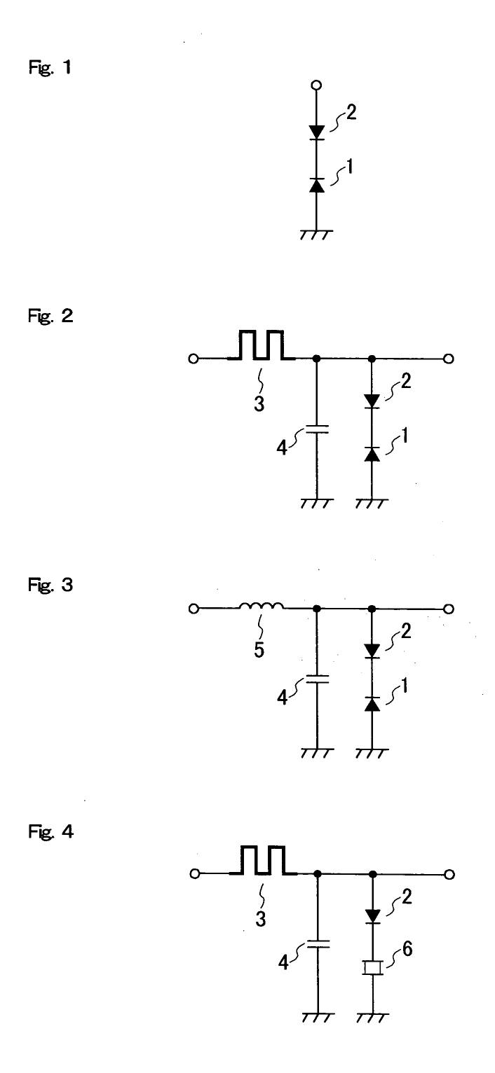

Moreover, it is possible to achieve the same effect as the lightning surge protection circuit shown in FIG. 2 by adopting the configuration shown in FIG. 4 where the surge absorber 1 of the lightning surge protection circuit shown in FIG. 2 is replaced with a varistor 6. It is also possible to achieve the same effect as the lightning surge protection circuit shown in FIG. 3 by adopting the configuration shown in FIG. 5 where the surge absorber 1 of the lightning surge protection circuit shown in FIG. 3 is replaced with the varistor 6.

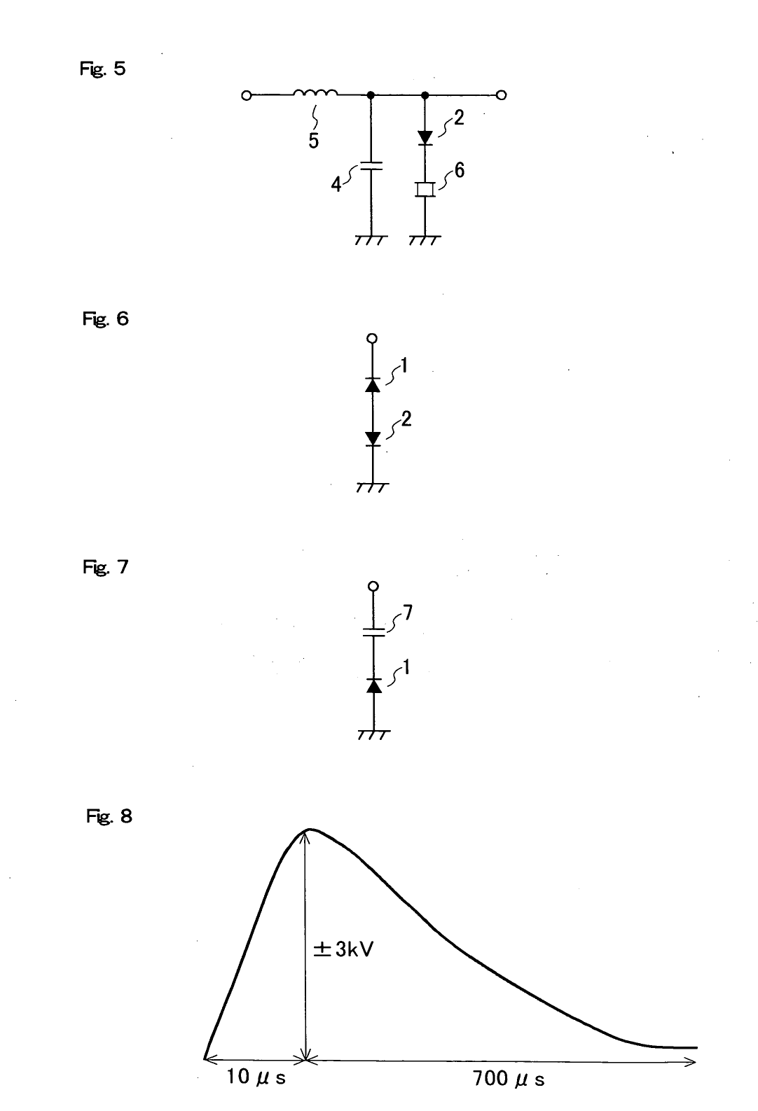

Next, another example of the configuration of the lightning surge protection circuit according to the present invention is shown in FIG. 6. It is to be noted that, in FIG. 6, such components as are found also in FIG. 1 will be identified with the same reference numerals, and description thereof will not be repeated. The lightning surge protection circuit shown in FIG. 6 differs from the lightning surge protection circuit shown in FIG. 1 in that the surge absorber 1 and the diode 2 change places. Specifically, in the lightning surge protection circuit shown in FIG. 6, a terminal of the surge absorber 1 corresponding to the anode of a diode is connected to the anode of the diode 2. The lightning surge protection circuit shown in FIG. 6 is used in such a way that the cathode of the diode 2 is grounded, and a terminal of the surge absorber 1 corresponding to the cathode of a diode is connected to a power supply line of a product such as an LNB or a SW-BOX. The lightning surge protection circuit shown in FIG. 6 has the same effect as the lightning surge protection circuit shown in FIG. 1. It is to be noted that the surge absorber 1 or the varistor 6 and the diode 2 can change places in the lightning surge protection circuits shown in FIGS. 2 to 5.

Next, still another example of the configuration of the lightning surge protection circuit according to the present invention is shown in FIG. 7. It is to be noted that, in FIG. 7, such components as are found also in FIG. 1 will be identified with the same reference numerals, and description thereof will not be repeated. The lightning surge protection circuit shown in FIG. 7 differs from the lightning surge protection circuit shown in FIG. 1 in that the diode 2 is replaced with a capacitor 7. Specifically, the lightning surge protection circuit shown in FIG. 7 is a serial circuit of the surge absorber 1 and the capacitor 7, and a terminal of the surge absorber 1 corresponding to the cathode of a diode is connected to one end of the capacitor 7. The lightning surge protection circuit shown in FIG. 7 is used in such a way that a terminal of the surge absorber 1 corresponding to the anode of a diode is grounded, and the other end of the capacitor 7 is connected to a power supply line of a product such as an LNB or a SW-BOX. The lightning surge protection circuit shown in FIG. 7 has the same effect as the lightning surge protection circuit shown in FIG. 1. It is to be noted that the surge absorber 1 and the capacitor 7 can change places in the lightning surge protection circuit shown in FIG. 7. Moreover, in the lightning surge protection circuits shown in FIGS. 2 to 5, the diode 2 can be replaced with the capacitor 7. Furthermore, in the lightning surge protection circuits shown in FIGS. 2 to 5, the diode 2 can be replaced with the capacitor 7, and the capacitor 7 and the surge absorber 1 or the varistor 6 can change places.

Next, a SW-BOX will be described as an example of the radio-frequency signal processing device according to the present invention. The SW-BOX is a unit that serves as a switch for switching a signal, and is provided between an LNB and a receiver so that a plurality of receivers receive an output signal from the LNB or a desired output signal is selected at the receiver side from among signals outputted from a plurality of LNBs corresponding to different satellites. The SW-BOX switches an output signal of the LNB based on a control signal (a digital signal as a pulse pattern) from the receiver. For this reason, the SW-BOX is provided with a plurality of receiver connection terminals and a plurality of LNB connection terminals.

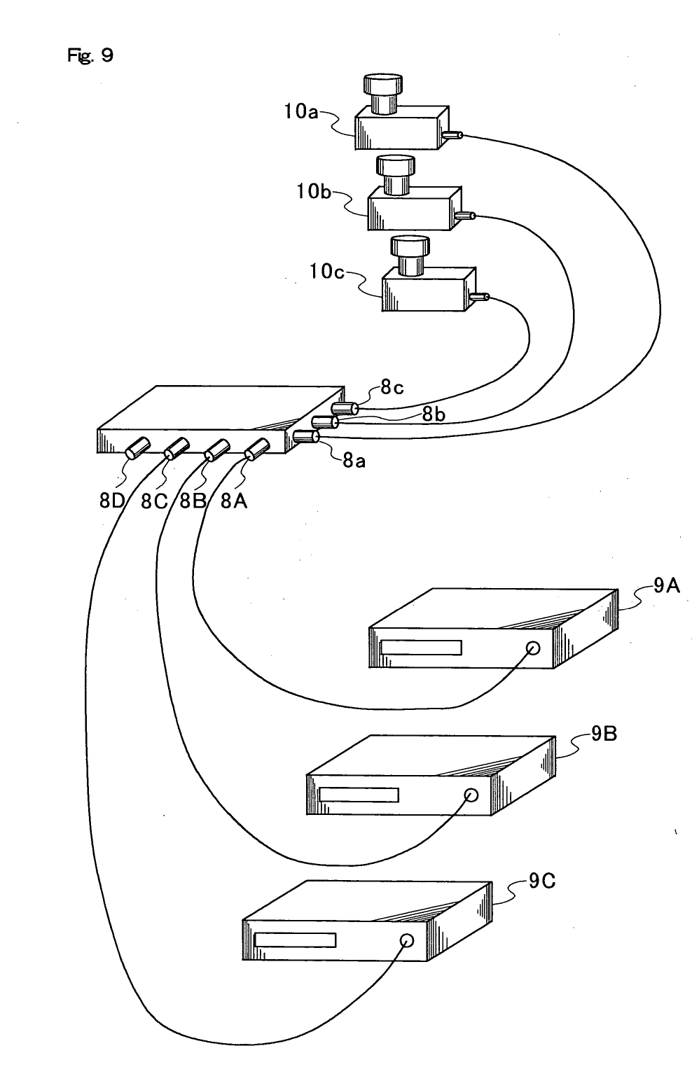

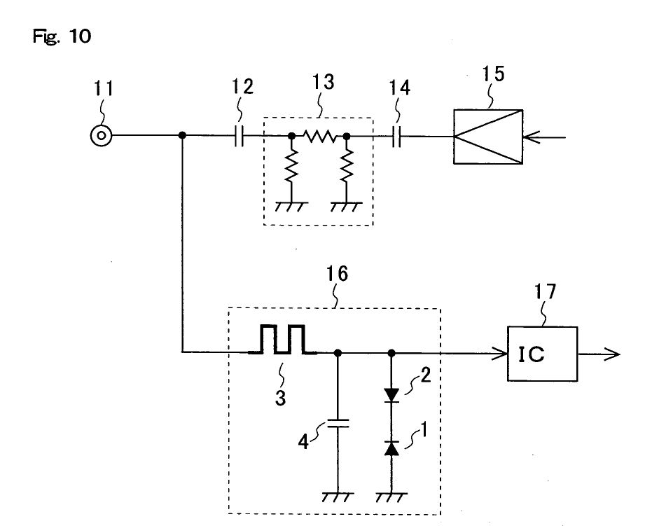

A SW-BOX having three LNB inputs and four receiver outputs is shown here as an example in FIG. 9. The SW-BOX 8 shown in FIG. 9 has four receiver connection terminals 8A to 8D and three LNB connection terminals 8a to 8c. Receivers 9A to 9C are respectively connected to the receiver connection terminals 8A to 8C of the SW-BOX 8 shown in FIG. 9 via cables. LNBs 10a to 10c are respectively connected to the LNB connection terminals 8a to 8c of the SW-BOX 8 shown in FIG. 9 via cables.

Since a DC current for driving the SW-BOX 8 and the LNBs 10a to 10c is fed to the SW-BOX 8 and the LNBs 10a to 10c from the receivers 9A to 9C, and an RF signal is transmitted to the receivers 9A to 9C from the receiver connection terminals 8A to 8C of the SW-BOX 8 shown in FIG. 9, an RF signal component (an AC component) and a DC component are separated in the SW-BOX 8. Moreover, since a control signal for switching an output signal (an RF signal) of the LNB is also superimposed on a DC signal, these AC components and DC components are all separated in the SW-BOX 8 and processed for transmission. These AC components and DC components thus separated are combined together, and then transmitted to the LNBs 10a to 10c from the LNB connection terminals 8a to 8c.

In order to protect the internal circuit from a lightning surge, it is necessary for the SW-BOX 8 to provide a lightning surge protection circuit for all of the external terminals (the receiver connection terminals 8A to 8D and the LNB connection terminals 8a to 8c). It is to be noted that the lightning surge protection circuit is generally provided between an external terminal and an internal circuit to enhance an protecting effect (see FIG. 10).

FIG. 10 shows the circuit configuration in the vicinity of the receiver connection terminal of the SW-BOX according to the present invention. It is to be noted that, in FIG. 10, such components as are found also in FIG. 2 will be identified with the same reference numerals, and description thereof will not be repeated. An RF line is provided with a ceramic capacitor 12 for cutting a DC component, a matching attenuator 13, a ceramic capacitor 14 for cutting a DC component, and an RF amplifier 15 from a receiver connection terminal 11 side. Also, a DC line is provided with a lightning surge protection circuit 16 according to the present invention and an IC 17 from a receiver connection terminal 11 side. In order to reduce transmission loss of an RF signal by trapping an RF signal entering the DC line, a line length of the microstrip line 3 inside the lightning surge protection circuit 16 according to the present invention is set at ¼ wavelength of an RF signal transmitted via the RF line. With this configuration, it is possible to prevent the ceramic capacitor 12 for cutting a DC component, the ceramic capacitor 14 for cutting a DC component, the RF amplifier 15, and the IC 17, which are likely to be damaged by a lightning surge, from being damaged thereby.

What is claimed is:

1. A lightning surge protection circuit comprising:
a serial circuit of a surge absorber and a diode.

2. A lightning surge protection circuit comprising:
a serial circuit of a varistor and a diode.

3. A lightning surge protection circuit comprising:
a serial circuit of a surge absorber and a capacitor.

4. A lightning surge protection circuit comprising:
a serial circuit of a varistor and a capacitor.

5. The lightning surge protection circuit of claim 1, further comprising:
a trap portion that traps a radio-frequency signal in a predetermined frequency band.

6. The lightning surge protection circuit of claim 2, further comprising:
a trap portion that traps a radio-frequency signal in a predetermined frequency band.

7. The lightning surge protection circuit of claim 3, further comprising:
a trap portion that traps a radio-frequency signal in a predetermined frequency band.

8. The lightning surge protection circuit of claim 4, further comprising:
a trap portion that traps a radio-frequency signal in a predetermined frequency band.

9. A radio-frequency signal processing device comprising:
a lightning surge protection circuit,
wherein the lightning surge protection circuit includes a serial circuit of a surge absorber and a diode.

10. A radio-frequency signal processing device comprising:
a lightning surge protection circuit,
wherein the lightning surge protection circuit includes a serial circuit of a varistor and a diode.

11. A radio-frequency signal processing device comprising:
a lightning surge protection circuit,
wherein the lightning surge protection circuit includes a serial circuit of a surge absorber and a capacitor.

12. A radio-frequency signal processing device comprising:
a lightning surge protection circuit,
wherein the lightning surge protection circuit includes a serial circuit of a varistor and a capacitor.

13. The radio-frequency signal processing device of claim 9,
wherein the lightning surge protection circuit further includes a trap portion that traps a radio-frequency signal in a predetermined frequency band.

14. The radio-frequency signal processing device of claim 10,
wherein the lightning surge protection circuit further includes a trap portion that traps a radio-frequency signal in a predetermined frequency band.

15. The radio-frequency signal processing device of claim 11,
wherein the lightning surge protection circuit further includes a trap portion that traps a radio-frequency signal in a predetermined frequency band.

16. The radio-frequency signal processing device of claim 12,
wherein the lightning surge protection circuit further includes a trap portion that traps a radio-frequency signal in a predetermined frequency band.

17. The radio-frequency signal processing device of claim 13, further comprising:
an RF (radio frequency) line; and
a DC (direct current) line,
wherein the RF line and the DC line are connected to each other, and
wherein the lightning surge protection circuit is provided on the DC line.

18. The radio-frequency signal processing device of claim 14, further comprising:
an RF (radio frequency) line; and
a DC (direct current) line,
wherein the RF line and the DC line are connected to each other, and
wherein the lightning surge protection circuit is provided on the DC line.

19. The radio-frequency signal processing device of claim 15, further comprising:
an RF (radio frequency) line; and
a DC (direct current) line,
wherein the RF line and the DC line are connected to each other, and
wherein the lightning surge protection circuit is provided on the DC line.

20. The radio-frequency signal processing device of claim 16, further comprising:
an RF (radio frequency) line; and
a DC (direct current) line,
wherein the RF line and the DC line are connected to each other, and
wherein the lightning surge protection circuit is provided on the DC line.
